(19) United States
(12) Patent Application Publication
(10) Pub. No.: US 2019/0212474 A1
(43) Pub. Date: Jul. 11, 2019

(54) NEW OCULAR LENS MADE OF A COMPOSITE MATERIAL FOR OPTICAL USE, AS WELL AS ITS METHOD OF OBTAINING

(71) Applicant: DALLOZ CREATIONS, Saint-Claude (FR)

(72) Inventors: Quoc LE QUANG, Saint-Claude (FR); Hien MY, Saint-Claude (FR); Rudy ROBILLARD, Genod (FR); Michel MONNERET, Saint-Claude (FR)

(73) Assignee: DALLOZ CREATIONS, Saint-Claude (FR)

(21) Appl. No.: 16/243,800

(22) Filed: Jan. 9, 2019

(30) Foreign Application Priority Data
Jan. 11, 2018 (FR) 18 00035

(51) Int. Cl. G02B 1/14

(52) U.S. Cl. CPC G02B 1/14; G02C 7/02

(57) ABSTRACT

The present invention relates to a new ocular lens made of a composite material for optical use, as well as its method of production.

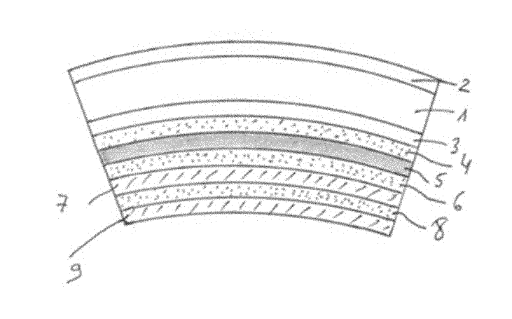

This material consists of a substrate (1) having a convex face facing the observer on which is deposited a layer (2) of anti-scratch varnish, and a concave face facing the wearer on which are deposited successively a layer (3) of anti-scratch varnish, a layer (4) made of a metallic film, a layer (5) made of precious metal, a layer (6) made of a metallic film, a metal oxide layer (7), a layer (8) of a metallic film and a layer (9) of metal oxide.

Application to solar or ophthalmic lenses or shields.

The present invention relates to a new ocular lens made of a composite material for optical use, as well as its method of production.

More specifically, the lens obtained from the material according to the present invention has a layer of a precious metal such as gold, or other precious metals which will be mentioned in the this description.

Some precious metals are already used on lenses to provide specific technical properties, for example: “gold” on fire helmets to filter infrared, also on some helmets of fighter pilots, wherein the aim is the protection of the eyes of the wearer of such lenses.

In the case of ocular lenses according to the invention, the layer of precious metal does not serve the technical role of protection, but fulfills a cosmetic role, wherein the aim is the appearance of the precious metal on the surface of the lens (as seen by observers of the lens), and the limitation of reflection on the internal face to make the lens comfortable for users.

European patent EP 2 274 648, filed in the name of Christian Dalloz Sunoptics, discloses a spectacle lens of the type comprising several layers, wherein one of the layers is a transparent substrate, while another layer, located on the observer's side of the lens, is a precious metal, wherein an antireflection layer is disposed between the transparent substrate and the precious metal layer.

In the type of lens described in the aforementioned European patent, the aspect “precious metal” is perceived mainly in the reflection of the last layer of the precious metal. If the latter is not resistant as in the case of gold or platinum, it is necessary to protect it by adding a protective layer. There is then the need to cover the layer of precious metal with a top coat varnish (having a characteristic of adhesion to the precious metal and also having an anti-scratch feature); this results in “visible” constructive interference due to:
the significant difference between the refractive index of the varnish and that of the precious metal;
the small thickness of the varnish deposited as the top coat on the gold layer.

U.S. Pat. No. 6,793,339 describes an ocular lens comprising a substrate having a concave face on the side of the lens wearer and a convex face on the observer's side, wherein the faces are covered with an anti-scratch varnish; and wherein a plurality of layers is furthermore disposed on the convex side, in the middle, or on the concave side of the ocular lens; wherein these layers consist of alternating dielectric materials and metallic materials. The choice of these materials and their thickness determine the color of the lens perceived by the observer.

The ocular lens according to the present invention overcomes these drawbacks and offers advantages which will be specified in the present description.

More specifically, the ocular lens according to the present invention, of the type comprising a substrate having a convex face facing the observer and a concave face facing the wearer of the lens, comprises:
a first layer of anti-scratch varnish disposed on the convex face of the substrate,
a second layer of anti-scratch varnish disposed on the concave face of the substrate,
a plurality of layers, including a layer made of a precious metal, disposed on the second layer of anti-scratch varnish, on the side facing the wearer of the lens, wherein the layer of precious metal is sandwiched between two metal films disposed under the second layer of anti-scratch varnish.

More preferably, the lens according to the present invention further comprises a layer of a metallic film sandwiched between two layers of metal oxide.

Advantageously, this sandwich layer of a metallic film/metal oxide layer is located under the sandwich precious metal layer/metallic film layers.

Other advantages and features will become apparent upon reading the description which follows, made with reference to the FIGURE schematically illustrating the various layers constituting a preferred embodiment of the ocular lens according to the invention.

### BRIEF DESCRIPTION OF THE DRAWING

The FIGURE schematically illustrates various layers constituting a preferred embodiment of the ocular lens

### DETAILED DESCRIPTION OF EMBODIMENTS

According to the FIGURE, the ocular lens according to the invention comprises a transparent substrate (1). This substrate (1) may be made of a mineral or organic material such as polycarbonate or any other material used in spectacle lenses such as polyamide, CR39 or NXT polymer, or a copolyester based on monomers: dimethyl terephthalate-1,4-cyclohexanedimethanol-2,2,4,4-tetramethylcyclobutane-1,3-diol.

On the convex face of the substrate (1) is disposed a layer of anti-scratch varnish (2), while on the concave portion of the substrate (1) is also disposed a layer of anti-scratch varnish (3). Each of these layers (2), (3) has a thickness of between 1 and 10 μm. The role of the layer (2) is to protect the substrate (1) against abrasion, while that of the layer (3) is to allow better adhesion of the layer (4) to the substrate (1).

The layer (4) consists of a metallic film made of a metal, preferably chromium, but that may also be made of another metal such as nickel, iron, titanium, aluminum, zinc, lead, tin, tantalum, tungsten or an alloy of these metals with each other or with chromium. This layer was inserted between the layer (3) of anti-scratch varnish and the layer (5) of precious metal to obtain better adhesion of the layer (5) of precious metal.

The layer (5) is made of precious metal selected from among the following metals: gold, silver, platinum, palladium, rhodium, ruthenium, scandium, osmium or iridium as well as one of the alloys obtained from these metals. It is this layer which will confer on the lens according to the invention, the desired aesthetic effect, namely the appearance of the precious metal in question. The arrangement of the layers (4), (5), (6) allows the suppression of the interference fringes appearing under certain conditions with regard to the ocular lens and that is the subject of the European patent EP 2 274 648; it also allows the precious metal constituting the layer (5) to be perfectly protected from physical and/or chemical attacks.

The layer (6) consists of a metallic film, wherein the chosen metal is one of the metals likely to constitute the layer (4).

The layer (7) consists of a metal oxide layer, such as silicon oxide, but it could also consist of titanium, tantalum or zirconium oxide.

The layer (8) consists of a metallic film, wherein the metal is chosen from those enumerated for producing the layers (4) or (6).

The layer (9), namely the one that will be closest to the eye of the lens wearer according to the invention, will be made of a metal oxide, wherein the metal is selected from the following metals: silicon, titanium, tantalum, zirconium.

The desired aspect of the “precious metal” is obtained by the rendering of all the layers (3), (4), (5), (6), (7), (8) and (9). The advantage of this arrangement is that the layer (5) of precious metal is sandwiched between two layers (4) and (6). Therefore, as has been previously stated, the layer (5) of precious metal is naturally protected, unlike the assembly described in the aforementioned patent EP 2 274 648 where the precious metal layer is outside and must therefore be protected by a protective layer.

The purpose of all the layers (6), (7), (8) and (9) is to limit the reflection on the concave face of the lens, whether this relates to the reflection towards the wearer compared to the first sandwich (4), (5), (6), or by the metallic film (8), and thus to enhance the “precious metal” appearance on the surface of the lens. It should be noted that the layer (6) is an anti-scratch varnish while also allowing better adhesion of the second sandwich (7), (8), (9).

In the case where the precious metal is gold, the preferred values of these layers are as follows:
layer (4): between 1 and 50 nm
layer (5): between 1 and 200 nm
layer (6): between 1 and 200 nm
layer (7): between 20 and 300 nm
layer (8): between 1 and 100 nm
layer (9): between 20 and 300 nm

Of course, for the sake of clarity, the relative thicknesses of the different layers are not respected. For the record, the substrate (1) has a convex portion facing the observer and a concave face located on the side facing the wearer of the lens, wherein the layer (2) is disposed on the convex portion of the substrate (1), while the layers (3), (4), (5), (6), (7), (8) and (9) are disposed on the concave portion of the substrate (1).

Various tests were carried out to establish whether the ocular lens according to the invention withstands extreme conditions:
resistance to heat: the ocular lens is kept in an oven at 90° C. for 60 minutes.
resistance to cold: the ocular lens is kept at −20° C. for two hours.
hot water test: the ocular lens is immersed in water heated to 80° C. for 10 minutes.
salt water immersion test: the ocular lens is immersed in a 3% saline solution of NaCl for 24 hours.

At the end of these tests and despite the combination of deep scratches+scotch test (normative test) performed on the ocular lens having undergone each of the tests, no detachment or segmentation of the layers is observed.

The ocular lens according to the invention will be used in the form of solar or ophthalmic lenses or shields.

According to a preferred embodiment of the ocular lens according to the invention, the anti-scratch coating layers (2) and (3) are applied by dipping the substrate (1) in a varnish bath or by any other application technique such as varnishing/coating by centrifugation that is known in this technical field under the term “flow coating”; wherein they may also be applied by the method of varnishing/coating by controlled flow that is known in this technical field under the term “spin coating” that is widely used on lenses whose substrate is made of CR39 thermosetting polymer, or else by spraying that is used for shields. The layers (4), (5), (6), (7), (8) and (9) are deposited one by one by vacuum evaporation.

1. Ocular lens of the type comprising a substrate having a convex face facing the observer and a concave face facing the wearer of the lens, of the type comprising:
a first layer of anti-scratch varnish disposed on the convex face of the substrate,
a second layer of anti-scratch varnish disposed on the concave face of the substrate,
a plurality of layers, including a layer made of a precious metal, selected from the group consisting of gold, silver, platinum, palladium, rhodium, ruthenium, scandium, osmium iridium, or an alloy obtained from these metals, disposed on the second layer of anti-scratch varnish, on the side facing the wearer of the lens, wherein the layer of precious metal is sandwiched between two layers of a metallic film.

2. Ocular lens according to claim 1, wherein the layer of precious metal is gold.

3. Ocular lens according to claim 1, wherein under the sandwich formed by the two layers of a metallic film and the layer of precious metal, is disposed a third layer consisting of a metallic film that is itself sandwiched between two layers of metal oxide.

4. Ocular lens according to claim 3, wherein the two layers of a metallic film and the third layer consisting of a metallic film is chromium.

5. Ocular lens according to claim 3, wherein the metal of the two layers of a metallic film and the third layer consisting of a metallic film is selected from among the following group of metals: nickel, iron, titanium, aluminum, zinc, lead, tin, tantalum, tungsten or an alloy of these metals with each other or with chromium.

6. Ocular lens according to claim 3, wherein the layers of metal oxide consist of silicon oxide.

7. Ocular lens according to claim 3, wherein the layers of metal oxide consist of a metal oxide selected from the following oxides: titanium oxide, tantalum oxide or zirconium oxide.

8. Ocular lens according to claim 1, wherein the thickness of the first and second layers is between 1 and 10 μm.

9. Ocular lens according to claim 3, wherein the thickness of the layers is as follows:
the first layer of the two layers of a metallic film: between 1 and 50 nm
the layer of precious metal: between 1 and 200 nm
the second layer of the two layers of a metallic film: between 1 and 200 nm
the first layer of metal oxide: between 20 and 300 nm
the third layer consisting of a metallic film: between 1 and 100 nm
the second layer of metal oxide: between 20 and 300 nm.

10. Method for obtaining an ocular lens according to claim 1, wherein the first and second layers are applied by dipping the substrate in a bath of varnish or by the technique of “flow coating”.

11. Method for obtaining an ocular lens according to claim 3, wherein the first layer of the two layers of a metallic film, the layer of precious metal, the second layer of the two layers of a metallic film, the first layer of metal oxide, the third layer consisting of a metallic film, and the second layer of metal oxide are deposited one by one by vacuum evaporation.

12. Solar or ophthalmic lenses or shields made of an ocular lens according to claim 1.
